(19) United States
(12) Patent Application Publication
(10) Pub. No.: US 2006/0015204 A1
(43) Pub. Date: Jan. 19, 2006

(54) Method of manufacturing a modular damper

(76) Inventors: Robert P. Carlstedt, Rochester Hills, MI (US); James J. Siesel, Canton, MI (US); Christopher T. Sledz, Armada, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/894,442

(22) Filed: Jul. 19, 2004

(51) Int. Cl. G06F 19/00

(52) U.S. Cl. 700/101; 29/407.05; 29/429; 700/117

(57) ABSTRACT

A piston valve assembly for a damper comprises a piston having a central hole and a fluid passageway spaced from the hole. A deflection disc having a central aperture is aligned with the hole. A hub, common across different dampers, includes a neck that is arranged in the hole and the aperture of the deflection disc. A retainer abuts an unthreaded outer surface of the hub. During assembly, the retainer is received on the cylindrical outer surface in a slip fit relation and secured to the hub under a predetermined clamp load. Throughout the manufacturing process, components of the piston valve assembly are marked with identifying information that may be compared to other identifying information on the piston assembly throughout the manufacturing process to ensure integrity of the piston valve assembly. The piston valve assembly and other assemblies can be sent to another OEM facility near the customer to manufacture dampers that satisfy build requests for low volume dampers.

### BACKGROUND OF THE INVENTION

This invention relates to dampers such as vehicle suspension shock absorbers, struts and the like. More particularly, the invention relates to a common hub design for piston valve arrangements enabling a more modular damper.

Dampers such as shock absorbers and struts are used in vehicles to absorb inputs from the roadway to provide a desirable vehicle ride. Typically, vehicle dampers employ a piston that moves through a cylinder having hydraulic fluid. The fluid flows through fluid passageways and valves in the piston, which absorbs the roadway inputs in the form of heat. The piston size, valves, and piston rod are selected based upon the particular vehicle and vehicle application, which requires the damper OEM to stock numerous parts for different vehicles and even for different suspension packages for the same vehicle.

One common type of piston valve assembly uses deflection discs on either side of the piston. The deflection discs at least partially block the fluid passages in the piston to regulate the fluid flow rate through the passages during the compression and rebound strokes of the damper. The number, size and thickness of the discs are selected to provide a desired ride characteristic for the vehicle, such as the firmness of the suspension. The OEM may stock over one hundred different deflection discs for different dampers. This same problem applies to damper base valves and other damper subassemblies.

The piston and deflection discs are secured in abutment with one another by the piston rod and nut. The rod includes a shoulder with a neck extending from the shoulder to support the piston and deflection discs. An end of the neck is threaded to receive the nut. The nut is tightened onto the rod to a predetermined torque so that the deflection discs are held securely against the piston. The damping characteristics of the damper are adversely affected if the deflection discs are not properly loaded against the piston. The piston valve assembly is not tested prior to final assembly of the damper. One problem is that it may difficult to consistently control the predetermined torque resulting in failure of the finally assembled damper during its final test, which results in scrap at the OEM. Moreover, the load on the deflection discs may decrease even after the predetermined torque has successfully been achieved and the damper has passed the final test.

Another problem with the proliferation of damper components is that it is difficult to manufacture low volume dampers cost effectively. An OEM receives the damper components from various suppliers and builds the dampers from one location. OEMs typically can only efficiently build dampers in large lot sizes. However, the OEM customers are increasingly requiring small lot sizes to that they have more flexibility during the vehicle build process. As a result, the OEMs have contracted with outside companies to build the unprofitable smaller lots.

Therefore, what is needed is a more modular damper design that reduces the number components stocked for different dampers. Also, what is needed is a method of manufacturing low volume dampers more efficiently.

### SUMMARY OF THE INVENTION AND ADVANTAGES

The present invention provides a piston valve assembly for a damper comprising a piston having a central hole and a fluid passageway spaced from the hole. A deflection disc having a central aperture is aligned with the hole. The deflection disc is arranged adjacent to the piston and at least partially blocks the fluid passageway for regulating the flow of hydraulic fluid between the fluid chambers when installed in the damper. An inventive hub includes a neck that is arranged in the hole and the aperture of the deflection disc. The hub is common between different piston valve assemblies. A retainer abuts an unthreaded outer surface of the hub. Said another way, a line parallel to a hub axis extends along the outer surface and lies in a plane tangential to the outer surface. In one example embodiment, the outer surface is cylindrical in shape having a smooth surface. During assembly, the retainer is received on the cylindrical outer surface in a slip fit relation. The retainer is secured to the outer surface by a securing material such as a weld bead.

The hub is an additional component of the piston valve assembly not found in the prior art. The retainer is received in a slip fit relationship on the hub and then welded thereto providing the load on the deflection disc to maintain the desired loading throughout the operation of the piston valve assembly. The hub is also common across different dampers and may receive different sized pistons and deflection discs so that the piston valve assembly may be used in different dampers.

The inventive piston valve assembly is manufactured using an inventive method of manufacturing. The method of manufacturing comprises the steps of providing the inventive hub and installing a deflection disc and piston on the hub. Of course, multiple deflection discs may be arranged on either side of the piston. The deflection disc and pistons are loaded to a predetermined clamp load. A retainer is placed on the hub in a slip fit relationship thereto and secured to the hub while the deflection disc and pistons are maintained under the predetermined clamp load. The retainer is secured to the hub, for example, by welding. Of course, this same process can also be used to manufacture base valves.

Throughout the manufacturing process, components of the piston valve assembly is marked with identifying information that is compared or correlated to other identifying information on the piston assembly throughout the manufacturing process to ensure integrity of the piston valve assembly. For example, the hub is marked with set-up identifying information indicating which component should be installed on the hub. Once the piston valve assembly is fully assembled, the subassembly is tested and marked with identifying information indicative with the test results. The tested subassembly is then shipped to a damper assembly location, which may be at a remote location from the piston valve assembly area, and assembled into a damper, which is then marked with identifying information.

The manufacture of subassemblies, for example by using the method and apparatus described above, enables OEMs to cost effectively manufacture small lot size dampers. The subassemblies are manufactured at the OEM's main facility that manufactures the large lot size dampers. However, subassemblies are also shipped to another OEM facility that is located in close proximity to the customer, for assembly into small lot size dampers. The second OEM facility, in one example, is mobile trailers located on the customer's property, for example in the customer's parking lot. The subassemblies arrive at the second OEM facility pretested and are assembled into dampers in response to a build request from the customer facility. Despite the smaller equipment and increased handling at the second OEM facility, the OEM is able to produce the small lot sizes more profitably than contracting the small lot sizes out while quickly satisfying the customer's build needs.

Accordingly, the above mentioned provides a modular damper design that reduces the number of components stocked for different dampers while providing consistent loading of the piston valve assembly.

### BRIEF DESCRIPTION OF THE DRAWINGS

Other advantages of the present invention can be understood by reference to the following detailed description when considered in connection with the accompanying drawings wherein:

FIG. 1 is a cross-sectional view of an inventive piston valve assembly including a common inventive hub;

FIG. 2 is a side elevational view of the inventive hub shown in FIG. 1 having identifying marks for the particular piston valve assembly;

FIG. 3 is a block diagram of the inventive manufacturing process for producing a damper having the inventive valve assembly;

FIG. 4 is a side elevational view of a fully assembled damper manufactured according an inventive manufacturing process; and

FIG. 5 is a schematic view of an inventive method of manufacturing taking advantage of the inventive subassembly.

### DETAILED DESCRIPTION OF THE PREFERRED EMBODIMENT

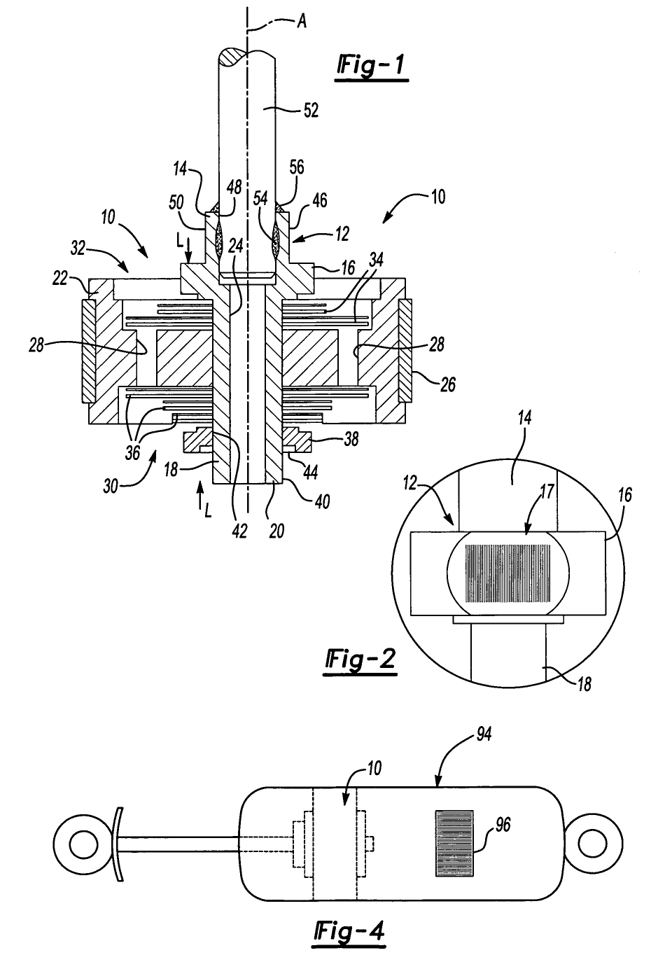

A piston valve assembly 10 of the present invention is shown in FIG. 1. The assembly 10 includes an inventive hub 12 that is designed to be used with different sized pistons and deflection discs to facilitate a more modular damper assembly. The hub 12 includes a first end 14 that is adapted to receive a piston rod. The first end 14 includes a shoulder 16 and a neck 18 extending from the shoulder 16 to a second end 20. The hub 12 is preferably marked with identifying information 17, for example by laser etching a bar code, that may be indicative of the components that will be installed on the hub 12 that will provide the particular piston valve assembly configuration, as shown in FIG. 2.

A piston 22 having a hole 24 is installed onto the hub 12 with the neck 18 received in the hole 24. Different sized pistons may be used on the same hub, for example, 25 mm, 30 mm, or 35 mm diameter pistons having the same sized central hole 24 could fit on the same hub. The neck 18 has a generally uniform cylindrical circumference along its length. The piston 22 includes an outer circumference 26 that engages the inner wall of the damper cylinder, as is well known in the art, when the damper is assembled.

The piston 22 includes one or more fluid passages 28 extending between compression 30 and rebound 32 sides of the piston 22. One or more compression deflection discs 34 are arranged on the rebound side 32 of the piston, and one or more rebound deflection disc 36 are arranged on the compression side 30 of the piston 22. The discs 34 and 36 include a central aperture that receives the neck 18. The discs 34 and 36 regulate the fluid flow through the fluid passages 28 to provide a desired damping characteristic as the piston valve assembly 10 moves through the fluid chambers and the damper. The discs 34 and 36 deflect upward and away from the sides 32 and 30 as the fluid within the fluid passage 28 exerts pressure on the discs 34 and 36, as is well known in the art. If the discs 34 and 36 are not firmly and consistently retained against the piston 22, the discs 34 and 36 will open under lower pressures resulting in undesired damping characteristics.

The neck 18 includes an outer surface 40. The surface 40 is preferably smooth, cylindrical, and unthreaded. The surface 40 has a line extending along a length parallel to a hub axis A. The line lies in a plane tangential to the outer surface. A retainer 38 includes a portion having a generally cylindrical inner surface 42 that is received in a slip fit relationship on the outer surface 40 of the neck 18.

The piston 22 and retainer 38 are loaded to a predetermined clamp load L to force the discs 34 and 36 firmly into abutment with the piston 22 and the shoulder 16 and retainer 38, in the example shown. While the assembly 10 is maintained under a predetermined clamp load L, a securing material 44 is used to secure the retainer 38 to the neck 18. The securing material 44 may be a weld bead. At this point in the piston valve assembly manufacturing process, a completed subassembly is provided. The assembly 10 may be marked with identifying information such as a laser etched bar code, in a similar manner to that shown in FIG. 2 indicating the results of the test.

Different size piston rods may be installed onto the assembly 10. To achieve this modularity in design, the hub 12 includes a collar 46 extending from the shoulder 16. The collar 46 includes an inside surface 48 and an outside surface 50. A solid rod 52, for example 12 mm in diameter, may be received in the collar 46 in close fitting relationship to the inside surface 48. The rod 52 may be impulse welded to the inside surface 48 forming a weld bead 54. The rod 52 may also be laser welded forming a weld bead 56 about the circumference of the rod 52 where it meets the collar 46 to form a seal past which fluid will not leak.

Alternatively, a different sized rod, for example 22 mm in diameter, may be secured to the same hub 12. The larger diameter rod is typically a hollow rod. The hollow rod is installed onto the collar 46 such that an inside surface of the rod is in close fitting relationship with the outside surface 50. The hollow rod is impulse welded to the collar forming a weld bead, and the rod may also be laser welded to the collar 46 forming a laser weld bead about the circumference of the rod where it meets the collar 46.

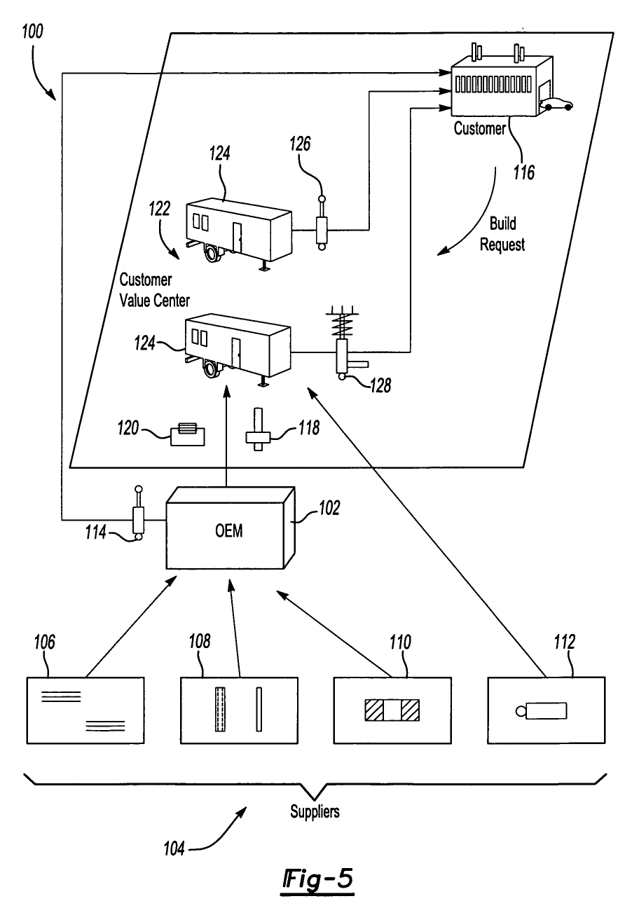

The inventive manufacturing process of the modular arrangement is schematically depicted in FIG. 5. Inventive manufacturing process 64 includes providing a common hub, as indicated at 66. The hub is marked with identifying information, such as a laser etched bar code, indicative of the piston valve assembly components, as indicated at 68. A desired size piston is selected, as indicated at 72, and the desired size and number of deflection disc is selected, as indicated at 74. By using a common hub, the inventory of pistons and discs may be reduced approximately 50%. The piston and discs are assembled onto the hub, as indicated at 70. The assembly is loaded to a predetermined clamp load, as indicated at 76. A retainer is installed onto the hub and secured to the hub while the piston valve assembly components are held under the predetermined clamp load, as indicated at 78.

The assembly is tested, as indicated at 80, and test information is marked onto the assembly, as indicated at 82. The quality of the subassembly is enhanced by the subassembly manufacturing process, which reduces the deviation of the performance characteristics within a lot. Ensuring that only the dampers meeting the test requirements are ultimately installed into a finished damper further enhances the quality of the damper. A desired size rod is selected, as indicated at 86 and secured to the hub, as indicated at 84. The subassembly is installed into the damper and the damper assembly is completed, as indicated at 88.

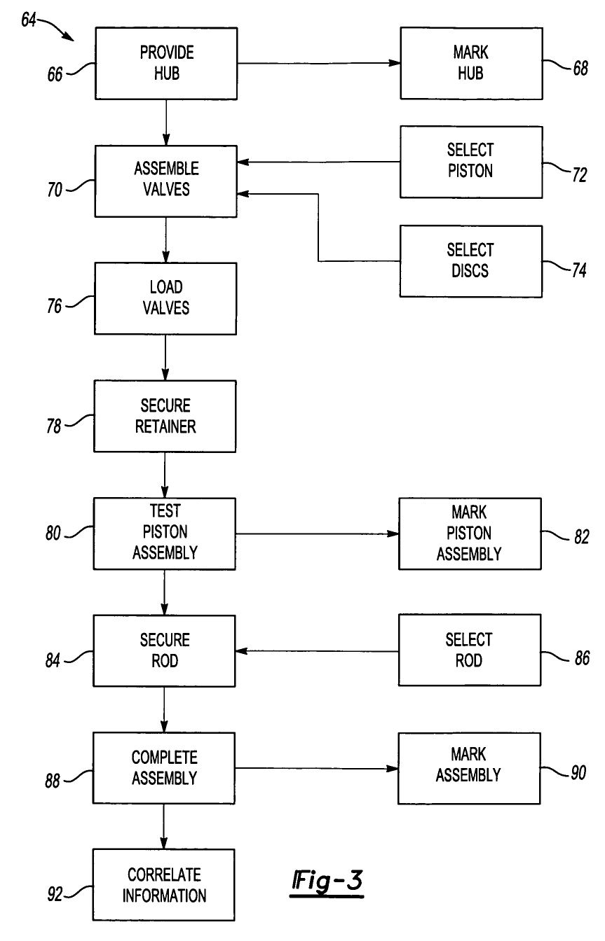

The damper 94, shown in FIG. 4, is marked with identifying information 96, which is indicated at 90 in FIG. 3. The identifying information on the hub, piston valve assembly and damper, may be correlated to one another, as indicated at 92, for any number of manufacturing or quality control purposes.

As will be appreciated by one of ordinary skill in the art from the discussion above, the inventive valve assembly increases not only the quality of the valve assembly but also enables increased manufacturing efficiency. Specifically, the OEM is able to assembly damper components from suppliers into discrete subassemblies that can be tested and transported. These subassemblies can then be assembled quickly to produce a completed damper assembly for the customer. Subassemblies may include the piston valve assembly with and without the inventive hub arrangement, base valve arrangements with and without the inventive hub arrangement, piston valve assemblies with and without the rod installed, and any other group of damper components that may be conveniently arranged into a subassembly.

FIG. 5 schematically depicts a business model method 100 of manufacturing a vehicle damper assembly for a vehicle manufacturing facility. The method is particularly well suited for manufacturing lower volume dampers that could not otherwise be efficiently manufactured by the OEM's main manufacturing facility. A first OEM facility 102 receives damper components from numerous supplier facilities 104 to produce a high volume production damper 114 for a vehicle assembly facility 116. The vehicle assembly facility 116 includes any facility in which the damper is assembled onto a vehicle structure, for example a vehicle chassis or chassis subassembly. Example damper components may include deflection discs 106, hollow and solid rods 108, bumpers 110, and shock bodies 112.

The first OEM facility 102 is typically remote from the customer's vehicle assembly facility 116, for example many miles. The first OEM facility 102 manufactures subassemblies, for example piston assemblies 118 and base valves 120, which are used to produce the high volume production damper 114. The subassemblies 118, 120 and other subassemblies are shipped, preferably subsequent to testing, to second OEM location or customer value centers 122 that are in close proximity to the vehicle assembly facility 116 and typically much close than the first OEM location. Some components may come directly from the suppliers 104. The customer value center 122, for example, is several mobile trailers 124 located in the customer's parking lot.

The customer value center 122 satisfies the customer's low volume damper build requests that could not otherwise be efficiently met by the first OEM facility 102. The customer value centers typically utilize smaller machines and increased labor and handling, but these disadvantages are offset by the ability to use subassemblies. The customer value center 122 assembles shock absorbers 126 and McPherson struts 128 in response to build requests from the vehicle assembly facility 116.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A method of manufacturing a vehicle damper assembly comprising the steps of:
a) receiving damper assembly components at a first OEM facility from multiple supplier facilities;
b) assembling the damper assembly components at the first OEM facility to produce subassemblies;
c) sending the subassemblies to a second OEM facility;
d) receiving a build request from a vehicle assembly facility and selecting from the subassemblies at the second OEM facility to produce a vehicle damper assembly complying with the build request; and
e) sending the vehicle damper assembly to the vehicle assembly facility from the second OEM facility to fulfill the build request.

2. The method according to claim 1, wherein one of the subassemblies is a valve assembly, the steps of assembling the valve assembly comprising the step of:
b1) installing a valve and valve body onto a longitudinal member;
b2) axially sliding a retainer onto the longitudinal member;
b3) loading the valve to a predetermined clamp load; and
b4) securing the retainer to the longitudinal member with the valve under the predetermined clamp load to provide a valve assembly.

3. The method according to claim 2, wherein the valve assembly is a base valve assembly.

4. The method according to claim 2, wherein the valve assembly is a piston valve assembly.

5. The method according to claim 2, wherein the longitudinal member is a hub and the vehicle damper assembly includes a rod secured to the hub.

6. The method according to claim. 5, comprising the step of selecting one of a hollow rod and a solid rod and securing the selected rod to the hub.

7. The method according to claim 2, comprising the step of marking the hub with set-up identifying information subsequent to performing step a).

8. The method according to claim 1, comprising the step of testing the subassembly subsequent to performing step b).

9. The method according to claim 8, comprising the step of marking the subassembly with subassembly identifying information subsequent to the step of testing the subassembly if the subassembly passed the testing step.

10. The method according to claim 9, comprising step d1) installing the subassembly into a cylinder to provide the vehicle damper assembly.

11. The method according to claim 10, comprising step d2) testing the vehicle damper assembly and marking the vehicle damper assembly with final assembly identifying information.

12. The method according to claim 11, comprising step d3) correlating the subassembly identifying information with the final assembly identifying information.

13. The method according to claim 1, wherein the first and second OEM facilities are remote from one another.

14. The method according to claim 13, wherein the second OEM facility is in closer proximity to the vehicle assembly facility than the first OEM facility.

15. A method of manufacturing a vehicle damper subassembly comprising the step of:
a) marking a damper component with set-up identifying information;
b) assembling the damper component into a damper subassembly;
c) testing the damper subassembly; and
d) marking the damper subassembly with subassembly identifying information relating to a test result from performing step c).

16. The method according to claim 15, comprising the steps of:
b1) installing a valve and valve body onto a longitudinal member;
b2) axially sliding a retainer onto the longitudinal member;
b3) loading the valve to a predetermined clamp load; and
b4) securing the retainer to the longitudinal member with the valve under the predetermined clamp load to provide the damper subassembly.

17. The method according to claim 16, wherein the damper component is the longitudinal member.

18. The method according to claim 17, wherein the longitudinal member is a hub and the damper assembly is a piston valve assembly, and a rod being secured to the hub.
